(19) United States
(12) Patent Application Publication
(10) Pub. No.: US 2017/0244228 A1
(43) Pub. Date: Aug. 24, 2017

(54) APPARATUS FOR DIVIDING A DUCT OR CONDUIT

(71) Applicant: WESCO Distribution, Inc., Pittsburgh, PA (US)

(72) Inventor: Jerry L. ALLEN, Sarasota, FL (US)

(21) Appl. No.: 15/418,685

(22) Filed: Jan. 28, 2017

Related U.S. Application Data
(60) Provisional application No. 62/299,196, filed on Feb. 24, 2016.

(51) Int. Cl. H02G 1/08; F16L 9/19

(52) U.S. Cl. CPC H02G 1/081; F16L 9/19

(57) ABSTRACT

A pliant tube is positioned in a duct thereby defining two compartments in the duct, one within the tube and the other between the tube and the duct. A pulling device, such as a pull tape or rope, is provided in each compartment and is adapted to be attached to a cable so that a cable can be pulled into each compartment of the duct.

### CROSS-REFERENCE TO RELATED APPLICATION

This application claims priority from U.S. Provisional Patent Application Ser. No. 62/299,196 filed on Feb. 24, 2016, which is incorporated herein by reference in its entirety.

### TECHNICAL FIELD

This invention relates to an apparatus for dividing a duct or conduit into compartments. More particularly this invention relates to such an apparatus which permits a cable or another device to be easily inserted into the conduit or duct.

### BACKGROUND ART

Many communications systems include conduits or ducts that extend for miles underground and which house one or more communication cables. A problem which has been addressed in various manners over the years relates to how to best utilize the capacity of the conduits or ducts and to provide an easy manner of inserting the cables into the conduits.

Since it would be extremely expensive to dig a new trench and install a new conduit in the ground every time that a new communications cable is needed, it is desirable to install another cable in an underground conduit which already has one or more cables therein. However, such can prove difficult to accomplish in that the cable already in the conduit offers a degree of friction and may be undulating through the conduit.

There have been many attempted solutions to this problem. One involved pushing a flat plate into the conduit in an effort to push the existing cable aside. Then the new cable could be installed on the other side of the plate. However, not only were these plates costly, but also they often proved difficult to install. Moreover, once installed, they often did not leave much room for the new cable and certainly not for additional cables.

Another solution was to install one or more rigid tubes in a conduit so that each tube could hold a cable. This solution proved workable only in large conduits which would have the capacity to carry the tubes. However, the tubes themselves wasted significant space in the conduit such that a conduit sized to hold five or more cables might, for example, only be able to hold three cables, each in its own duct.

Probably the most successful solution has been a fabric innerduct sold under the trademark MAXCELL® by WESCO Distribution, Inc. of Pittsburgh, Pa. and shown in U.S. Pat. No. 6,262,371. The product shown in that patent is a fabric innerduct which is formed with one or more compartments each of which can receive a cable. This innerduct is advantageous in that it is easy to insert a cable into a compartment because the fabric is pliant such that it can move as the cable is being inserted, and the fabric provides less friction than the rigid tubes previously described. Moreover, the fabric walls take up far less conduit space than the rigid tubes thereby giving the conduit more cable capacity. However, this product must be first inserted into an underground conduit, and then the cable or cables may be inserted therein. Such adds cost to the overall installation process.

Another device which is an attempt to replace the rigid tube concept is shown in U.S. Pat. No. 9,242,419. In that concept, the edges of a substrate are molded into the walls of a conduit, and the substrate extends across the conduit to divide it into compartments. Such involves a complex manufacturing process which results in an expensive conduit.

As a result, the need exists for a simple, inexpensive, and reliable divider for a conduit or tube which consumes a minimal amount of space in the conduit or tube.

### DISCLOSURE OF THE INVENTION

It is thus an object of one aspect of the present invention to provide a method and apparatus which relates to dividing a duct into compartments which allows cables to be easily positioned into the compartments.

It is an object of another aspect of the present invention to provide an apparatus, as above, which takes up minimal space in the conduit or duct.

It is an object of a further aspect of the present invention to provide an apparatus, as above, which is inexpensive to manufacture.

It is an object of yet another aspect of the present invention to provide a method of forming the duct having the dividing concept.

These and other objects of the present invention, as well as the advantages thereof over existing prior art forms, which will become apparent from the description to follow, are accomplished by the improvements hereinafter described and claimed.

In general, an apparatus to divide a longitudinally extending duct into compartments includes a longitudinally extending pliant tube positioned in the duct. The space within the tube defines a first compartment, and the space between the tube and the duct defines a second compartment.

A method of installing at least one cable in a longitudinally extending duct includes the steps of positioning a longitudinally extending tube made of a pliant material in the duct, positioning a longitudinally extending pulling device in the tube, positioning a second longitudinally extending pulling device between the tube and the duct, and using one of the pulling devices to pull a cable into the duct.

Another aspect of the present invention relates to a method of forming a divided duct, and it includes the steps of positioning a pulling device in a pliant tube, locating a second pulling device outside of the pliant tube, and extruding a duct around the pliant tube and the second pulling device.

A preferred exemplary conduit dividing apparatus and method according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a broken away elevational view of a conduit or duct of the type that would be installed underground.

FIG. 2 is a sectional view through the conduit or duct taken substantially along line 2-2 of FIG. 1, and showing the divider of the present invention.

FIG. 3 is a view like FIG. 2 but showing two cables installed in the conduit or duct.

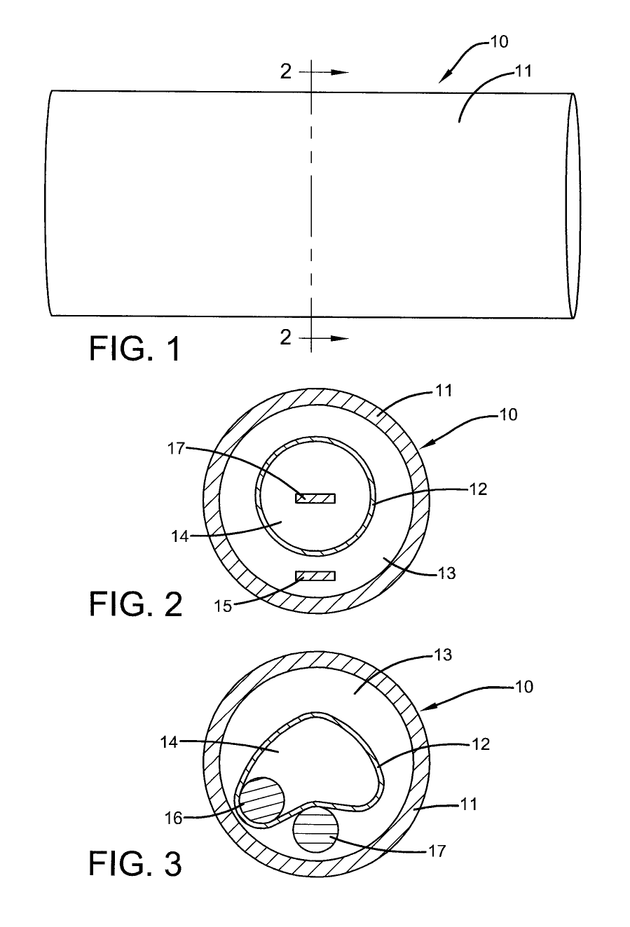

### PREFERRED EMBODIMENT FOR CARRYING OUT THE INVENTION

An apparatus made in accordance with the present invention is indicated generally by the numeral 10 in the drawings. A conduit or duct 11, which is preferably made of an extruded high density polyethylene material, receives a pliable tube 12 along its entire length. Tube 12 can be made of a thin fabric material having a low coefficient of friction, and when positioned in duct 11, tube 12 defines two spaces or compartments within duct 11. A first compartment 13 is located radially between tube 12 and duct 11, and a second compartment 14 is located within tube 12. Each compartment can be provided with a pull tape, rope, or other pulling device 15.

When it is desired to insert a cable 16 into duct 11, the cable is attached to one of the pull tapes 15 and pulled into the compartment of that tape, for example, compartment 14. Then at a later date when there is a need for another cable 17, it is attached to the other tape or rope in compartment 13 and the cable is conveniently pulled into the duct 11 without interference from the first cable. Specifically, tube 12 will protect both cables from abrasion or the like, and because of its pliant nature, it will move out of the way of the second cable being pulled into duct 11.

Duct 11 may be extruded around tube 12 and tapes 15 during the manufacturing process to form the complete assembly. That is, a pulling device 15 is positioned in the pliant tube 12, and a second pulling device is located adjacent to and outside of the tube 12. Then, in a manner known in the art, the duct 11 can be extruded around the tube 12 and the second pulling device 15 resulting in the apparatus 10 shown in FIG. 2. Then apparatus 10 can be inserted into a conduit which is already buried in the ground, or apparatus 10 can itself be buried in the ground without the need for a conduit.

In view of the foregoing, it should be evident that an apparatus described herein accomplishes the objects of the invention and otherwise substantially improves the art.

What is claimed is:

1. Apparatus to divide a longitudinally extending duct into compartments comprising a longitudinally extending pliant tube positioned in the conduit thereby creating a first space within the tube defining a first compartment and a second space between the tube and the duct defining a second compartment.

2. The apparatus of claim 1 further comprising a pulling device in each compartment and adapted to be attached to a cable to pull the cable into the compartments.

3. The apparatus of claim 2 wherein the pulling device is a tape.

4. The apparatus of claim 2 wherein the pulling device is a rope.

5. The apparatus of claim 1 wherein the pliant tube is made of a fabric material.

6. A method of installing at least one cable in a longitudinally extending duct comprising the steps of positioning a longitudinally extending tube made of a pliant material in the duct, positioning a longitudinally extending pulling device in the tube, positioning a second longitudinally extending pulling device between the tube and the duct, and using one of the pulling devices to pull the cable into the duct.

7. The method of claim 6 further comprising the step of using the other pulling device to pull a second cable into the duct without allowing the second cable to touch the cable.

8. A method of forming a divided duct comprising the steps of positioning a pulling device in a pliant tube, locating a second pulling device outside of the pliant tube, and extruding a duct around the pliant tube and the second pulling device.
